(19) United States
(12) Patent Application Publication
(10) Pub. No.: US 2006/0207272 A1
(43) Pub. Date: Sep. 21, 2006

(54) Control apparatus using time proportioning control

(75) Inventors: Hirofumi Hirayama, Tokyo (JP); Fumihiro Sugawara, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: YAMATAKE CORPORATION, Tokyo (JP)

(21) Appl. No.: 11/372,337

(22) Filed: Mar. 9, 2006

(30) Foreign Application Priority Data
Mar. 16, 2005 (JP) 2005-075477
Mar. 16, 2005 (JP) 2005-075478

(51) Int. Cl. B64D 13/00; G05D 23/32; A47J 39/00; G05D 23/19

(52) U.S. Cl. 62/157; 165/238; 165/201; 236/91 D

(57) ABSTRACT

A control apparatus used in a control system in which the cycle time of a time proportioning signal is long, for example, a temperature control system using a cooler. Even if a manipulation value MV with respect to the cooler is drastically changed along with change of a control target value SP, the activation timing of a time proportioning output section is reset with the changing timing, so that a time proportioning signal Tₒₙ is newly generated. Alternatively, with the changing timing, the time proportioning output section is reactivated to generate the deficiency of the time proportioning signal Tₒₙ according to an increasing amount of the manipulation value MV. As a result, the time proportioning signal Tₒₙ is changed with an excellent follow-up ability.

### BACKGROUND OF THE INVENTION

1. Field of the Invention

The present invention relates to a control apparatus using time proportioning control, which is suitable for controlling temperature by ON/OFF controlling, for example, a cooler.

2. Description of the Related Art

In the case of temperature control of a thermostat, temperature control of plastic materials used for injection molding, and the like, the heating capacity of a heater and the cooling capacity of a cooler are suitably selected to be used. This type of control is called heat and cool control. The heat and cool control is constituted entirely to find a manipulation value MV with respect to the heater or cooler on the basis of deviation between the control target temperature that is set by the operator (set point SP) and the temperature of a controlled object, which is detected by a sensor (process value PV), to control the actuation of the heater and cooler according to the manipulation value MV (see Unexamined Japanese Patent Application Publication No. 5-289704, for example). Specifically, the heat and cool control, for example, ON/OFF controls the conductivity of the heater and ON/OFF controls the actuation of a compressor included in the cooler according to the manipulation value MV found in the above-mentioned manner.

The manipulation value MV is found by a PID control calculation incorporated, for example, into a feedback control loop (see Unexamined Japanese Patent Application Publication No. 2004-227062, for example). When the actuation of the cooler (compressor) is controlled in the above-mentioned control system, a time proportioning signal corresponding to the manipulation value MV is used. The time proportioning signal is a signal obtained by varying the proportion of ON time to OFF time of an output signal within a prescribed period (cycle time) according to the manipulation value MV. To be concrete, for example, if the manipulation value MV is 50%, the time proportioning signal for ON/OFF controlling the operation of the cooler is outputted as signal that defines the first half time of one cycle time as ON (High), and the second half time as OFF (Low).

In case that the operation of the cooler (compressor) is controlled, the cycle time of the time proportioning signal is set as long as, for example, 10 to 30 seconds in consideration of the durability (life duration) of an actuator serving as a mechanical moving part of the cooling control system. In contrast, the conductivity control of the heater is performed without using mechanical moving parts. Therefore, for example, the cycle time is set as short as about one second.

In the control system in which the cycle time of the time proportioning signal is set long as in the case where the operation of the cooler is ON/OFF controlled, for example, when the manipulation value MV is drastically changed along with a shift of the control target temperature (set point SP), if the timing of the change is in the middle of the cycle time, the time proportioning signal is not changed until the next cycle time. It is therefore undeniable that a considerable control delay occurs. To be specific, even if the cycle time of the time proportioning signal is 30 seconds, and the manipulation value MV is noticeably changed at the time point when the cycle time elapses by 10 seconds; the time proportioning signal is not changed until the next cycle time starts after 20 seconds. This causes the problem that a desired control result cannot be attained.

### SUMMARY OF THE INVENTION

It is an object of the present invention to provide a control apparatus using time proportioning control, capable of achieving a responsive control result by changing a time proportioning signal with an excellent follow-up ability in a control system where the cycle time of the time proportioning signal is long, for example, even if a manipulation value MV is considerably changed along with a shift of control target temperature (set point SP).

Specifically, an object of the present invention is to provide a control apparatus using time proportioning control, which is suitable, for example, for a situation in which the operation of a cooler is ON/OFF controlled to implement the temperature control of a thermostat or the like.

In order to accomplish the above-mentioned object, the control apparatus using time proportioning control according to the present invention generates a time proportioning signal for controlling a state of a controlled object in synchronization with a prescribed period according to deviation between a control target value with respect to the controlled object and a value indicative of the state of the controlled object. The control apparatus has a manipulation value detecting section that finds deviation between a control target value with respect to the controlled object and a value indicative of a state of the controlled object as a manipulation value of a device for controlling the controlled object; a time proportioning output section that is activated in synchronization with a prescribed period, generates a time proportioning signal corresponding to the manipulation value found by the manipulation value detecting section, and provides the signal to the device; and an output control section that, when the control target value is changed within the period, resets the activation timing of the time proportioning output section with the changing timing or reactivates the time proportioning output section according to an increasing rate of the manipulation value.

In other words, when the control target value is changed, the control apparatus using time proportioning control according to the present invention resets the generation timing of the time proportioning signal and newly generates the time proportioning signal in synchronization with the reset timing. When the deviation is changed along with the change of the control target value, the control apparatus newly additionally generates a time proportioning signal that is deficient in elapsed ON time of the time proportioning signal within a current cycle time, which has been outputted up to the time point of the change of deviation.

Preferably, the device for controlling the controlled object is a cooler, and the controlled object is temperature to be controlled by operation of the cooler. Alternatively, devices for controlling the controlled object are a cooler and a heater, and the controlled object is temperature to be controlled by alternative operation between the cooler and the heater.

The time proportioning output section operates the device for controlling the controlled object within the prescribed period through time corresponding to the manipulation value in synchronization with timing defining the period, and then generates a signal for halting the device as the time proportioning signal.

Concretely, when operating the cooler to control temperature, the time proportioning output section generates as the time proportioning signal a signal defining the proportion of ON time in which the cooler is operated in the prescribed period. When selectively operating the cooler or heater to control temperature, the time proportioning output section alternatively generates as the time proportioning signal a signal defining the proportion of ON time in which the cooler is operated within a first period determined according to the specifications of the cooler or a signal defining the proportion of ON time in which the heater is operated within a second period determined according to the specifications of the heater.

The output control section resets the time proportioning output section with the changing timing of the control target value and produces a time proportioning signal corresponding to a new manipulation value from the time proportioning output section in synchronization with the reset timing.

Alternatively, when the manipulation value is changed within the period along with the change of the control target value, the output control section finds difference between a new manipulation value and a manipulation value corresponding to the time proportioning signal that has been outputted from the time proportioning output section up to the time point of change of the manipulation value. When the new manipulation value is large, the output control section reactivates the time proportioning output section with the time point of change of the manipulation value viewed as trigger and newly generates a time proportioning signal corresponding to difference of the manipulation values.

Specifically, the output control section compares the elapsed ON time of the time proportioning signal that has been outputted up to the time point of change of the deviation with the ON time corresponding to the manipulation value that has been newly found. If the ON time is longer than the elapsed ON time, the output control section generates a time proportioning signal of the ON time corresponding to difference between the ON time and the elapsed ON time.

When a control target value SP with respect to the controlled object is changed, the apparatus thus constituted resets the generation timing of the time proportioning signal, and generates a time proportioning signal corresponding to a manipulation value MV that is newly found along with the change of the control target value SP in synchronization with the reset timing. Consequently, the apparatus makes it possible to prevent control delay attributable to the cycle time of the time proportioning signal and to achieve a responsive control result. Furthermore, the apparatus simply resets the cycle time of the time proportioning signal and newly generates a time proportioning signal with the reset timing applied as basis, so that it is possible to effectively upgrade the control response thereof by carrying out simple control.

Especially in case that the actuation (operation) of the cooler is ON/OFF controlled to perform temperature control, the apparatus merely shifts a start time point of the cycle time by implementing the reset processing, instead of shortening the cycle time of the time proportioning signal. The apparatus then makes it possible to improve the control response thereof, avoiding sacrificing the durability (life duration) of an actuator included in a cooling control system.

According to another aspect of the apparatus, for example, in case that the control target value SP with respect to the controlled object is changed, and accordingly the deviation between the control target value SP and the value indicative of the state of the controlled object is changed, the time proportioning signal over a time period corresponding to difference between the ON time and the elapsed ON time is newly generated with the time point of change of the deviation viewed as trigger if the ON time of the time proportioning signal corresponding to the new deviation is longer than the elapsed ON time of the time proportioning signal within the current cycle time, which has been outputted up to the time point of change of the deviation. To be short, if the ON time of the time proportioning signal is insufficient in the cycle time, the apparatus newly generates and outputs a time proportioning signal corresponding to the insufficient time.

As a result, according to the apparatus, the sum of the ON time of the time proportioning signal in the cycle time corresponds to the changed deviation. Therefore, a responsive control result can be achieved while avoiding control delay attributable to the cycle time of the time proportioning signal. Moreover, according to the apparatus, the cycle time of the time proportioning signal is not shifted. Even if a plurality of controlled object devices are operated in synchronization with one another, the synchronization of the control system with respect to the controlled object devices is not disturbed.

Especially when the operation of the cooler is ON/OFF controlled to perform the temperature control, the apparatus can increase the ON time of the time proportioning signal without shortening the cycle time of the time proportioning signal and without shifting the cycle time. With the apparatus, therefore, it is possible to improve the control response, for example, while maintaining the synchronization with the other devices at the same time, moreover nearly without sacrificing the durability (life duration) of the actuator included in the cooling system.

### BRIEF DESCRIPTION OF THE DRAWINGS

The present invention will become more fully understood from the detailed description given hereinbelow and the accompanying drawings which are given by way of illustration only, and thus, are not limitative of the present invention, and wherein:

FIG. 1 is a schematic constitution view of a temperature control system using a control apparatus using time proportioning control according to a first embodiment of the present invention;

FIG. 2 is a view showing a control process of reset processing of a time proportioning period (cycle time) in the control apparatus using time proportioning control illustrated in FIG. 1;

FIG. 3 is a timing diagram showing a control pattern of a time proportioning signal in the control apparatus using time proportioning control illustrated in FIG. 1;

FIG. 4 is a view showing an advantage of the time proportioning control according to the present invention in comparison with a conventional example;

FIG. 5 is a view showing relationship between PID output and manipulation values for heating and cooling in the temperature control system using a heater and a cooler at the same time;

FIG. 6 is a view showing a schematic constitution of a substantial part of the control apparatus using time proportioning control in the temperature control system using the heater and the cooler at the same time;

FIG. 7 is a schematic constitution view of the temperature control system employing the control apparatus using time proportioning control according to a second embodiment of the present invention;

FIG. 8 is a timing diagram showing a control pattern of the time proportioning signal in the control apparatus using time proportioning control illustrated in FIG. 7;

FIG. 9 is a view showing a generation control process of the time proportioning signal in the control apparatus using time proportioning control illustrated in FIG. 7; and

FIG. 10 is a view showing a changing processing of a control parameter at the time of change of a manipulation value MV.

### DETAILED DESCRIPTION OF THE PREFERRED EMBODIMENTS

A control apparatus using time proportioning control according to an embodiment of the present invention will be described below with reference to the drawings, taking as an example the case in which a cooler is ON/OFF controlled by a time proportioning signal in order to perform temperature control of a controlled object.

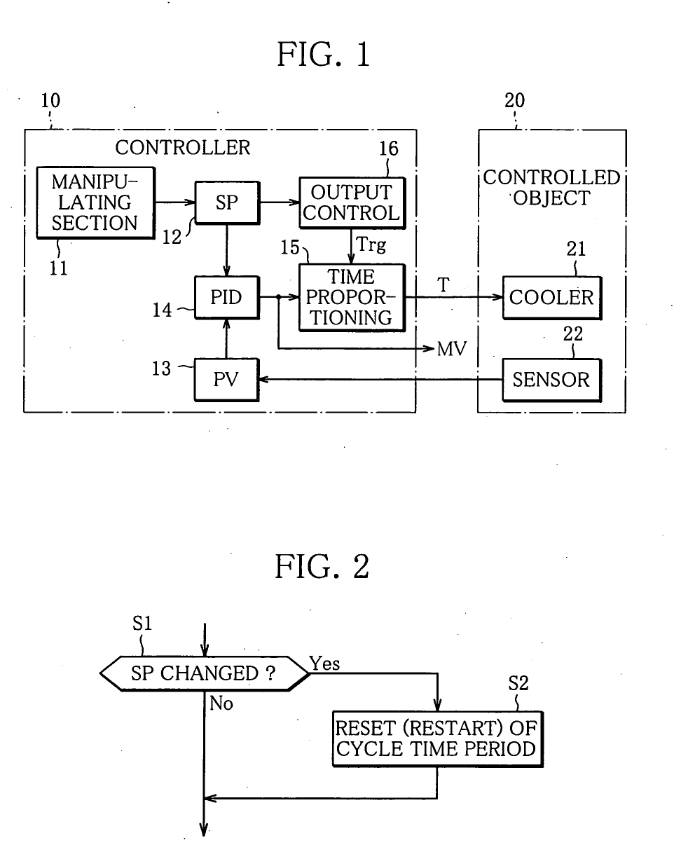

FIG. 1 shows a schematic constitution of a control system in the control apparatus using time proportioning control according to a first embodiment. In FIG. 1, reference numeral 10 represents a control apparatus (controller) using time proportioning control, which is constituted with a microprocessor and the like as main bodies. Reference numeral 20 denotes a controlled object, such as a thermostat or the like. Temperature of the controlled object 20 (to be exact, the temperature of the thermostat or the like is the controlled object) is controlled by a cooler 21. The temperature thereof (process value PV) is detected by a temperature sensor 22.

The controller (control apparatus using time proportioning control) 10 has control target temperature (target set point SP) 12 that is set by the operator through a manipulating section 11 basically such as a keyboard and a touch panel. The controller 10 includes a PID control section (manipulation value detecting section) 14 that, on the basis of deviation from temperature (process value PV) 13 of the controlled object 20, which is detected by the temperature 22, finds as PID output a manipulation value MV corresponding to the deviation, for example, by PID calculation. The controller 10 is further provided with a time proportioning output section 15 that finds a time proportioning signal Tₒₙ corresponding to the manipulation value (PID output) MV in every prescribed period (cycle time).

The PID output is made up of uninterruptible voltage output falling in the range of from 0 to 10 V corresponding to the manipulation value MV, for example, falling in the range of from 0 to 100% or uninterruptible current output falling in the range of from 4 to 20 mA. The time proportioning signal Tₒₙ is made up of a signal that is turned OFF after the proportion of signal output time of a continuous ON state in a cycle time (period), for example, of 30 seconds is changed to be linear over the range of from 0 to 100% correspondingly to the manipulation value MV in the range of from 0 to 100%. The cooler 21 is actuated only in an ON period of the time proportioning signal Tₒₙ by the time proportioning signal Tₒₙ, to thereby refrigerate the controlled object 20.

Basically as to the controller 10 with such a function, the first embodiment of the present invention is characterized in that there is provided an output control section 16 that monitors the control target temperature (target set point SP) 12 that is set by the manipulating section 11, and resets the cycle time in the time proportioning output section 15 when the control target temperature (target set point SP) 12 is changed. In other words, as illustrated in FIG. 2, the output control section 16 constantly monitors whether or not the control target temperature (target set point SP) 12 is changed <Step S1>. By resetting the cycle time of the time proportioning signal Tₒₙ when the change of the control target temperature (target set point SP) 12 is detected, the time proportioning signal Tc corresponding to the manipulation value MV at the time is found again <Step S2>.

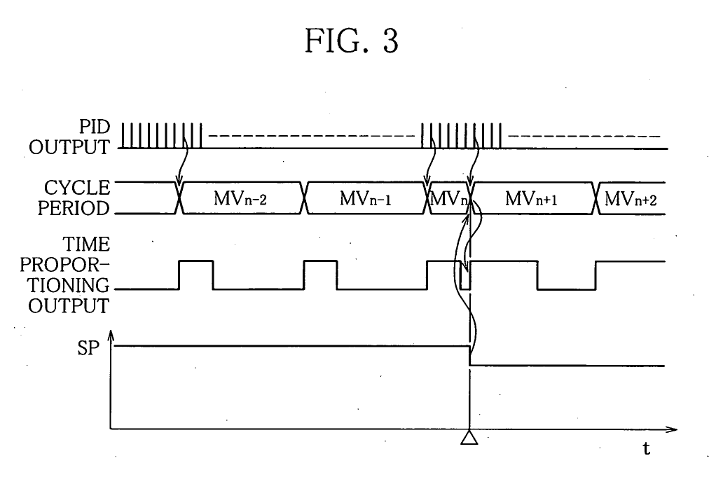

Specifically, the output control section 16, as illustrated in FIG. 3 showing operation timing thereof, resets the cycle time regardless of the elapse of the cycle time and sets the reset timing as a start time point of a new cycle time when the control target temperature (target set point SP) 12 is changed. The output control section 16 then generates and outputs a new time proportioning signal Tₒₙ according to the PID output (manipulation value MV) found by the reset timing.

With the time proportioning control apparatus constituted to reset the cycle time of the time proportioning signal and generate the new time proportioning signal Tₒₙ from the reset timing in the above manner, even if the control target temperature (target set point SP) 12 is changed, the actuation of the cooler 21 can be immediately controlled according to deviation between the control target temperature (target set point SP) 12 that has been changed and the temperature (process value PV) 13 of the controlled object 20. This makes it possible to resolve control response delay and to achieve a desired control result with an excellent follow-up ability. Moreover, only by adding a simple control algorithm for resetting the cycle time of the time proportioning signal Tₒₙ, the control response can be upgraded as control specifications (cycle time) with respect to the cooler 21 are maintained.

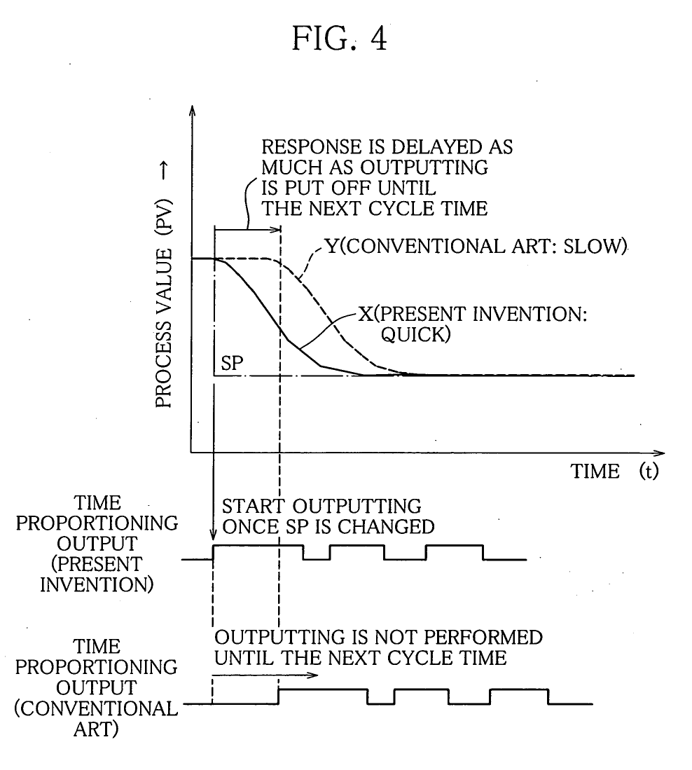

That is to say, as illustrated in FIG. 4 showing a response characteristic X of the time proportioning control according to the present invention and a response characteristic Y of conventional time proportioning control in comparison, a new time proportioning signal Tₒₙ is quickly provided at the time point when the target set point SP is changed in the present invention. It is then possible to actuate the cooler 21 without delay to control the temperature of the controlled object 20 and to cause the temperature to follow up the new target set point SP immediately. Response with respect to the change of the target set point SP can be enhanced.

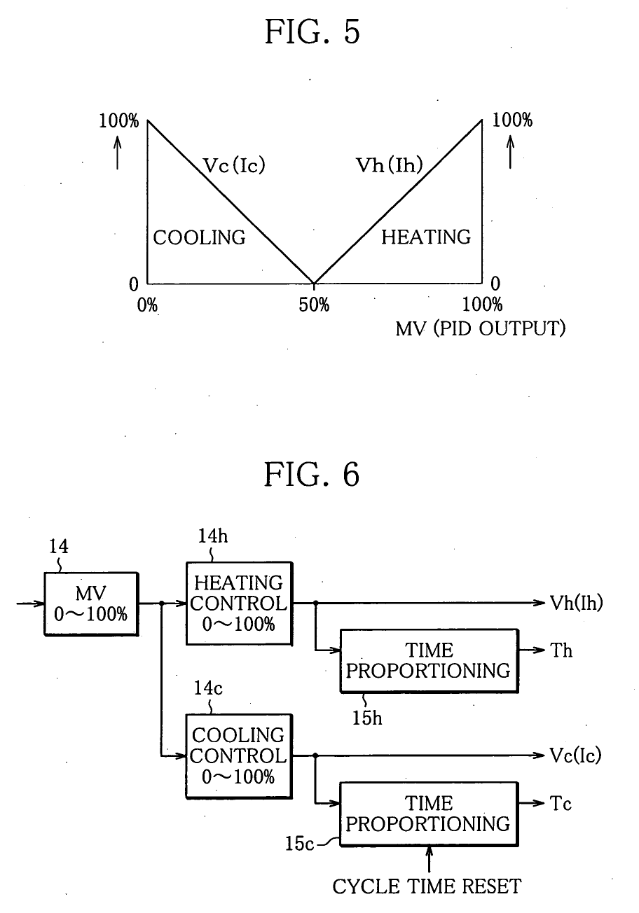

When the temperature control of the controlled object 20 is performed, the cooling capacity of the cooler 21 and the heating capacity of the heater are occasionally used at the same time. In such a case, for example, as shown in FIG. 5, the PID output provided as the manipulation value MV falling in the range of from 0 to 100% is converted with 50% as a boundary into a manipulation value MVₕₑₐₜ for heating control, falling in the range of from 0 to 100%, and a manipulation value MV_{cool} for cooling control, falling in the range of from 0 to 100%. According to the manipulation values MVₕₑₐₜ and MV_{cool}, the heater and the cooler are alternatively actuated. Again, for example, as illustrated in FIG. 6 showing the constitution of a substantial part, according to the manipulation values MVₕₑₐₜ and MV_{cool}, time proportioning signals Th and Tc thereof are found, to thereby implement the ON/OFF control of the heater and cooler in every prescribed period (cycle time).

However, the time proportioning control with respect to the heater is carried out with a short period as described, and only the time proportioning control with respect to the cooler 21 is performed with a long period. It is only the time proportioning control with respect to the cooler 21 in most cases, which has the problem of control response delay. Therefore, as described, when the time proportioning signal Tₒₙ is to be changed along with a great change in the manipulation value MV, it is sufficient to reset the cycle time on the cooler 21 side.

When the temperature control of the controlled object (thermostat or the like) 20 is implemented using the heater and the cooler at the same time as in the above case, if the PID output is changed in the vicinity of 50%, it is required to immediately actuate the cooler 21 from the state in which the cooler 21 is out of operation due to a time proportioning signal Tc of 0%. To be concrete, this is the case in which the manipulation value MV is changed to 45% from a state in which the heater is actuated with a manipulation value MV of 55%, and it becomes necessary to switch from the heater to the cooler 21 to be actuated. Even in such a situation, according to the time proportioning control apparatus of the present invention, the cycle time of the time proportioning signal Tc with respect to the cooler 21 is reset as described along with a great change in the manipulation value MV. Therefore, the cooler 21 can be immediately actuated by the time proportioning control at the time point when the control mode is switched from heating to cooling. This makes it possible to effectively prevent a switching delay of the control mode and achieve the desired control result without delay.

Furthermore, because of the reset function of the cycle time, for example, when the autotuning disclosed in Unexamined Japanese Patent Application Publication No. 2004-227062 is implemented, even if the implementation timing is in the middle of the time proportioning period, the time proportioning signal can be changed to 100% without delay. Accordingly, the autotuning can be efficiently carried out.

For example, in case that the time proportioning period (cycle time) is controlled by overflow of a counter, and simultaneously a discrete value of the counter and the PID output value are compared to each other to generate the time proportioning signal, it is sufficient to carry out the resetting of the time proportioning period (cycle time) by resetting the counter.

When the cycle time of the time proportioning signal is reset, it is possible to apply compensation to the time proportioning signal that is newly generated according to the elapsed time of the time proportioning period at that point, to thereby suppress a rapid change of the time proportioning signal. When the control target temperature (target set point SP) 12 is changed, the resetting of the time proportioning period (cycle time) may be suitably carried out after the degree of change of the manipulation value MV along with the change of the control target temperature 12 is judged. Specifically, only if the change of the manipulation value MV is greater than a prescribed threshold value, the resetting of the time proportioning period (cycle time) is performed. If the change of the manipulation value MV is small, the reset processing may be omitted. Needless to say, the present invention is similarly applicable to the case in which a controlled object other than the above-mentioned temperature is to be subjected to the time proportioning control.

A second embodiment of the control apparatus using time proportioning control according to the present invention will described below.

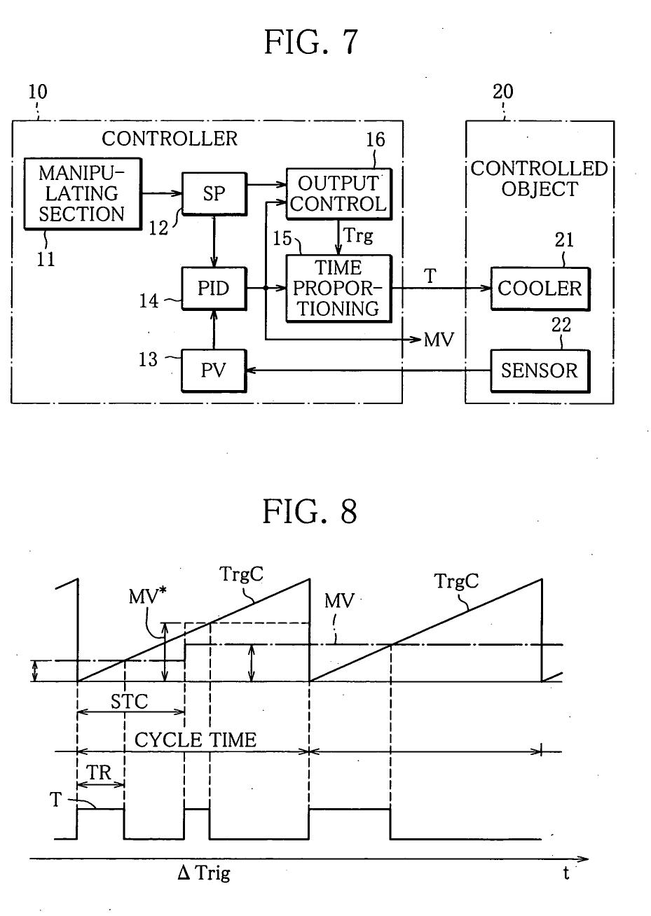

In the second embodiment, the output control section 16 is constituted, as illustrated in FIG. 7 showing a schematic constitution of the control system thereof, so as to control the actuation of the time proportioning output section 15 as described below when the control target temperature (target set point SP) 12 that is set by the manipulating section 11 is changed or when the manipulation value (PID output) MV found by the PID control section 14 is drastically changed. Specifically, the output control section 16 is so constituted as to control the actuation of the time proportioning output section 15 to add an ON-time time proportioning signal corresponding to a changing amount of the manipulation value (PID output) MV within the cycle time.

To be concrete, for example, when the manipulation value (PID output) MV is changed to 50% after the time proportioning output section 15 outputs the time proportioning signal Tₒₙ with time width corresponding to 30% of the cycle time in a state where the manipulation value (PID output) MV is 30%, the output control section 16 controls the actuation of the time proportioning output section 15 so as to additionally output the time proportioning signal Tₒₙ with time width corresponding to the changing amount of the manipulation value (PID output) MV, namely 20%, with the time point of the change viewed as trigger. Due to the additional output of the time proportioning signal Tₒₙ, total output time (ON time) of the time proportioning signal Tₒₙ in the cycle time is adjusted to 50%, to thereby follow the change of the manipulation value (PID output) MV at once.

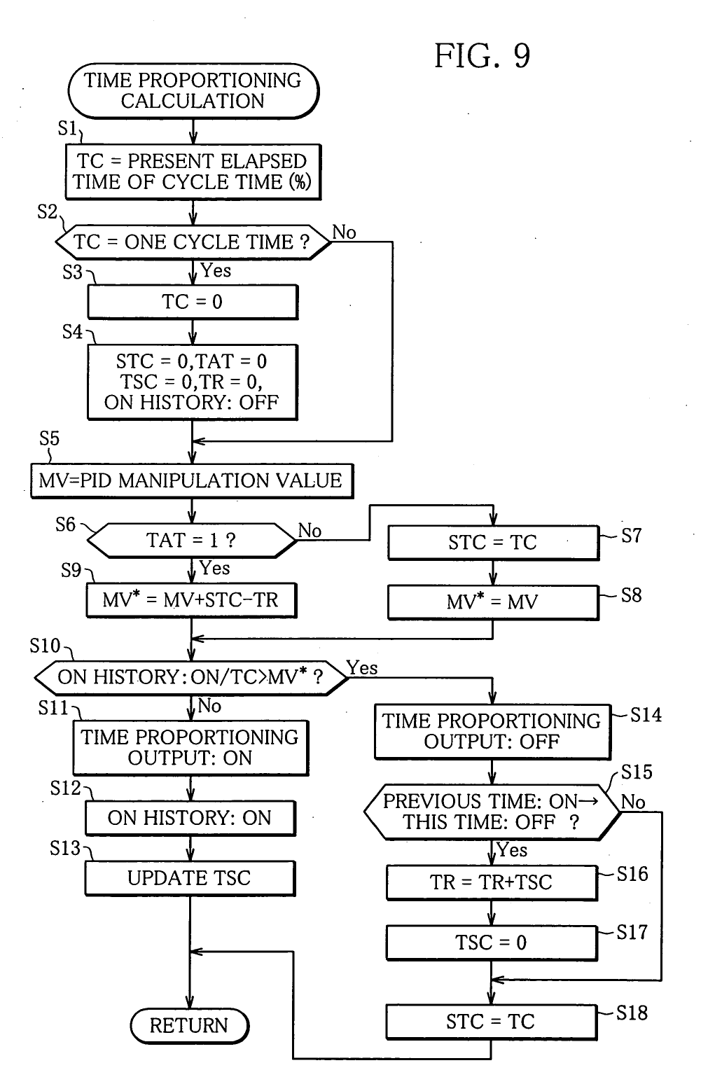

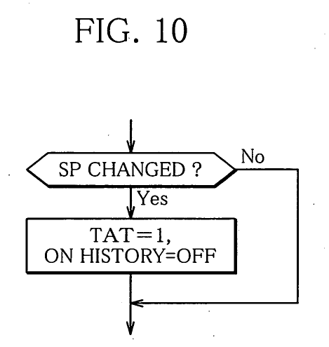

The generation of the time proportioning signal Tₒₙ in the time proportioning output section 15 based on the control of the output control section 16 will be described with reference to a timing diagram illustrated in FIG. 8, following control processes shown in FIGS. 9 and 10.

The time proportioning output section 15 has a counter for computing, for example, a value corresponding to 0 to 100% through one cycle time. The time proportioning output section 15 is so constituted as to compare the manipulation value (PID output) MV indicative of a value in the range of from 0 to 100% and the discrete value of the counter (counter value) TC as shown in FIG. 2, to thereby generate and output as the time proportioning signal Tₒₙ a signal that is ON through a period in which the manipulation value MV is greater than the counter value TC.

When the set point SP is changed in the middle of the cycle time or when the manipulation value (PID output) MV is considerably changed, the time proportioning output section 15 is controlled by the output control section 16, and a time proportioning signal Tₒₙ with time width corresponding to the changing amount of the manipulation value MV is newly generated with the time point of the change of the manipulation value MV viewed as trigger in the following manner.

Concretely, the time proportioning calculation in the time proportioning output section 15 is first obtained with the discrete value of the counter (counter value) TC used as present elapsed time of the cycle time (%) as illustrated in FIG. 9 <Step S1>. Subsequently, a determination is made as to whether the discrete value TC thereof reaches one cycle time (100%) or whether one cycle time is finished <Step S2>. If the counter value TC reaches 100%, the counter is reset to initialize the counter value TC to [0] <Step S3>. Parameters STC, TAT, TSC and TR used for control of the additional generation of the time proportioning signal Tₒₙ are initialized to [0], and at the same time the ON history (flag) of the time proportioning signal Tₒₙ is initialized to OFF <Step S4).

The ON history (flag) of the time proportioning signal is information showing whether the time proportioning signal Tₒₙ has already been outputted within one cycle time. Generally when the ON history of the time proportioning signal is ON [1], the generation of a new time proportioning signal Tₒₙ within the cycle time is prohibited. The parameter STC is information showing the elapsed time (ON time) at the time point when the time proportioning signal Tₒₙ is turned ON. The parameter TAT is information (flag) showing whether the time proportioning signal Tₒₙ that is currently outputted has been added within one cycle time or whether the addition of the time proportioning signal Tₒₙ is commanded. The parameter TSC is information showing the total of time in which one time proportioning signal Tₒₙ is ON. The parameter TR is information showing output cumulative time of the time proportioning signal Tₒₙ within one cycle time.

After the initialization processing along with the finish of one cycle time is completed as described, or if the present elapsed time of the cycle time, namely the discrete value (counter value) TC, is less than one cycle time, firstly the PID output at the time is obtained as the manipulation vale MV used for the generation (output control) of the time proportioning signal Tₒₙ <Step S5>. PID outputs are obtained one after another, for example, in every 0.1 second with a shorter period than one cycle time that is set as sufficiently long as 30 seconds or the like, for example, in consideration of life duration of the actuator that turns on/off the cooler 21. In other words, a processing routine shown in FIG. 9 is repeatedly implemented at high speed in synchronization with the period in which the PID output is obtained.

After the manipulation value MV is obtained in the above manner <Step S5>, a determination is made as to whether a condition (trigger) for adjusting the time proportioning signal Tₒₙ within one cycle time is produced <Step S6>. This determination is made by searching the parameter TAT. The parameter TAT is set ON [1] when the manipulation value MV is updated along with the change of the set point SP, for example, as illustrated in FIG. 10. At the time of updating the manipulation value MV, the ON history (flag) of the time proportioning signal is forcibly set OFF. Due to this forcible OFF setting of the ON history (flag), for example, even if the time proportioning signal Tₒₙ has already been outputted within one cycle time, the generation of the time proportioning signal Tₒₙ within the cycle time is allowed again.

When it is confirmed that the parameter TAT is [0], and that the condition (trigger) for adjusting the time width of the time proportioning signal Tₒₙ is not particularly produced, there is no change in the manipulation value MV, and it is not required to newly generate the time proportioning signal Tₒₙ. Therefore, the discrete value TC is directly received as parameter STC <Step S7>. Furthermore, the present manipulation value MV is directly obtained as an after-mentioned manipulation value MV* <Step S8>. The elapsed time from the time point when the current cycle time is started to the present moment is controlled, and after-mentioned processing from Step S10 is implemented.

If the parameter TAT is [1], and the condition (trigger) for adjusting the time width of the time proportioning signal Tₒₙ is established <Step S6>, that is to say, if the manipulation value MV is changed in the middle of one cycle time, the manipulation value MV* for generating the time proportioning signal Tₒₙ corresponding to changing amount of the manipulation value MV is obtained on the basis of the manipulation value MV that has been newly obtained at the time of the change of the manipulation value MV <Step S9>.

For example, if the manipulation value MV is increased along with the change of the set point SP, in order to generate the time proportioning signal Tₒₙ with time width corresponding to the increasing amount in addition to the time proportioning signal Tₒₙ that has been already outputted, a value of the parameter STC is added to the manipulation value MV newly obtained, and a value of the parameter TR indicative of the time width of the time proportioning signal Tₒₙ outputted in the past is deducted, to thereby obtain the manipulation value MV* of the time proportioning signal to be newly generated as:
MV*=MV+STC−TR
<Step S9>.

The processing compensates time-elapse amount with respect to the counter value TC by adding the value of the parameter STC that is the elapsed time from the start time point of the cycle time to the time point of the change of the manipulation value MV in order to additionally generate a new time proportioning signal Tₒₙ in comparison with the discrete value (counter value) TC with the time point of the change of the manipulation value MV viewed as trigger. However, when the new time proportioning signal Tₒₙ is generated in comparison between the thus compensated value and the counter value TC, the time width thereof corresponds to the changed manipulation value MV.

Therefore, the time width (parameter TR) of the time proportioning signal Tₒₙ that has already been outputted in the cycle time is deducted from the value that has been added with the parameter STC to be compensated [MV+STC], to thereby find the manipulation value MV* added only with a compensation amount corresponding to the changing amount of the manipulation value MV as [MV+STC−TR]. The manipulation value MV* found by the above processing is compared to the counter value TC.

Thereafter, a determination is made as to whether the ON history of the time proportioning signal is ON [1] or whether the discrete value TC is greater than the manipulation value MV* <Step S10>. If the ON history of the time proportioning signal is OFF [0], and the manipulation value MV* is greater than the discrete value TC, a condition for outputting the time proportioning signal Tₒₙ is satisfied. Therefore, the time proportioning signal Tₒₙ is first turned ON to be outputted <Step S11>, and the ON history of the time proportioning signal is turned ON [1] <Step S12>. The value of the parameter STC is updated, and the ON time (duration) of the time proportioning signal Tₒₙ is controlled <Step S13>.

If the ON history of the time proportioning signal is ON [1] or if the discrete value TC is greater than the manipulation values MV/MV*, that is, if the manipulation values MV/MV* is less than the discrete value TC <Step S10>, this means that the condition for outputting the time proportioning signal Tₒₙ is not satisfied. In such cases, first of all, the time proportioning signal Tₒₙ is turned OFF to stop the output thereof <Step S14>. Subsequently, a determination is made as to whether the time proportioning signal Tₒₙ is ON [1] in the previous processing routine, and whether the time proportioning signal Tₒₙ is OFF [0] in the present processing routine <Step S15>.

When the time proportioning signal Tₒₙ becomes OFF for the first time in the present processing routine, the parameter TSC indicative of the total output time of the present time proportioning signal Tₒₙ is added to the parameter TR indicative of the cumulative ON time of the time proportioning signal Tₒₙ, to thereby update the parameter TR <Step S16>. The parameter TSC is initialized to [0] <Step S17>. After the initialization of the parameter TSC or in Step S14, if it is determined that the time proportioning signal Tₒₙ is ON also in the previous processing routine, the discrete value TC is newly set as parameter STC, to thereby update the elapsed time in which the time proportioning signal Tₒₙ is ON from the start time point of the cycle time <Step S18>.

By sequentially performing the above processing routines over and over, in case that the manipulation value MV is changed during one cycle time, the time proportioning signal Tₒₙ with time width corresponding to the changing amount is additionally generated so as to follow the change of the manipulation value MV with the time point of change of the manipulation value MV viewed as trigger. To be specific, when the manipulation value MV is changed within the cycle time after the manipulation value MV and the counter value TC are compared to each other, and the time proportioning signal Tₒₙ with time width corresponding to the manipulation value MV is outputted, the time proportioning signal Tₒₙ with time width corresponding to the changing amount is newly generated and outputted with the time point of the change viewed as trigger. As a result, the total output time of the time proportioning signal Tₒₙ in the cycle time corresponds to the manipulation value MV that has been changed. Consequently, correction of the time proportioning signal Tₒₙ is immediately made along with the change of the manipulation value MV, regardless of the period of the cycle time.

With the time proportioning control apparatus, even if the control target temperature (target set point SP) 12 is changed, the actuation of the cooler 21 can be quickly controlled according to deviation between the control target temperature (target set point SP) 12 that has been changed and the temperature (process value PV) 13 of the controlled object 20. It is therefore possible to solve the control response delay and obtain the desired control result with an excellent follow-up ability. Moreover, by adding the simple control algorithm for additionally generating the time proportioning signal Tₒₙ with time width corresponding to the changing amount of the manipulation value MV, the control response can be improved as the control specifications (cycle time) with respect to the cooler 21 are maintained.

In the same manner as the case shown in FIG. 5, the present invention makes it possible to immediately generate a new time proportioning signal Tₒₙ at the time point when the target set point SP is changed. Therefore, the controlled object is controlled without delay, making it possible to cause the controlled object to follow up a new target set point SP instantaneously. As a consequence, it is possible to upgrade the response with respect to the change of the target set point SP.

The present invention is not limited to the above-described embodiments. Needless to say, the present invention is similarly applicable, for example, to the case in which a controlled object other than the above-mentioned temperature is subjected to the time proportioning control. Naturally, various modifications can be made in the algorithm for newly generating the time proportioning signal Tₒₙ at the time point of the change of the manipulation value MV. To be short, the present invention can be modified in various ways without deviating from the gist thereof.

What is claimed is:

1. A control apparatus using time proportioning control, comprising:
a manipulation value detecting section that finds deviation between a control target value with respect to a controlled object and a value indicative of a state of said controlled object as a manipulation value of a device for controlling said controlled object;
a time proportioning output section that is activated in synchronization with a prescribed period, generates a time proportioning signal corresponding to the manipulation value found by said manipulation value detecting section, and provides the signal to said device; and
an output control section that, when said control target value is changed within said period, resets activation timing of said time proportioning output section with the changing timing or reactivates said time proportioning output section according to an increasing amount of said manipulation value.

2. The control apparatus using time proportioning control according to claim 1, wherein:
the device for controlling said controlled object is a cooler, and said controlled object is temperature to be controlled by operation of said cooler.

3. The control apparatus using time proportioning control according to claim 1, wherein:
devices for controlling said controlled object are a cooler and a heater, and said controlled object is temperature to be controlled by alternative operation between said cooler and said heater.

4. The control apparatus using time proportioning control according to claim 1, wherein:
said time proportioning output section operates the device for controlling said controlled object within the prescribed period in synchronization with timing defining said period through time corresponding to said manipulation value, and thereafter generates a signal for halting said device as said time proportioning signal.

5. The control apparatus using time proportioning control according to claim 4, wherein:
when the cooler is operated to control temperature, said time proportioning output section generates as said time proportioning signal a signal defining proportion of ON time in which said cooler is operated within the prescribed period.

6. The control apparatus using time proportioning control according to claim 4, wherein:
when temperature is controlled by alternatively operating the cooler or heater, said time proportioning output section alternatively generates as said time proportioning signal a signal defining proportion of ON time in which said cooler is operated in a first period determined according to specifications of said cooler or a signal defining proportion of ON time in which said heater is operated in a second period determined according to specifications of said heater.

7. The control apparatus using time proportioning control according to claim 1, wherein:
said output control section resets said time proportioning output section with changing timing of said control target value and obtains a time proportioning signal corresponding to a new manipulation value from said time proportioning output section in synchronization with the reset timing.

8. The control apparatus using time proportioning control according to claim 1, wherein:
when the manipulation value is changed within said period along with change of said control target value, said output control section finds difference between a new manipulation value and a manipulation value corresponding to said time proportioning signal outputted from said time proportioning output section up to the time point of the change of said manipulation value, reactivates said time proportioning output section with the time point of change of said manipulation value viewed as trigger when the new manipulation value is great, and newly generates a time proportioning signal corresponding to the difference between said manipulation values.

9. The control apparatus using time proportioning control according to claim 8, wherein:
said output control section compares elapsed ON time of said time proportioning signal outputted up to the time point of change of said deviation with ON time corresponding to the manipulation value that has newly been found, and if said ON time is longer than said elapsed ON time, generates a time proportioning signal of ON time corresponding to difference between said ON time and said elapsed ON time.
